(19) United States
(12) Patent Application Publication
(10) Pub. No.: US 2005/0235011 A1
(43) Pub. Date: Oct. 20, 2005

(54) Distributed object classification

(75) Inventors: Dennis W. Minium JR., Sammamish, WA (US); Bill S. Essary, Sammamish, WA (US); Xiongjian Fu, Sammamish, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/824,961

(22) Filed: Apr. 15, 2004

(51) Int. Cl. G06F 17/30

(52) U.S. Cl. 707/203

(57) ABSTRACT

The present invention provides a system and method for unrelated tools to categorized elements they control according to a common centrally managed classification scheme. The invention also provides a mechanism for storing, retrieving, and modifying classifying information. Users of unrelated tools that employ the subject invention see a single and consisted user interface.

### TECHNICAL FIELD

The present invention relates generally to computers and more particularly toward optimizing application interactions.

### BACKGROUND

Individuals designing and architecting systems typically utilize a variety of tools, each designed for a particular purpose. Although conventional integrated development environments have gone a long way toward integrating a variety of tools that deal with part of the process, sometimes there are other tools that are needed that are not part of the integrated development environment. This makes it difficult and confusing for users as they must try and understand a plurality of different programming implementations.

For example, the organization of an enterprise development project enables team members to communicate meaningful information about the state of a project's progress. It also provides a system of grouping software artifacts in some logical fashion. The problem is that the project classification hierarchy can vary from company to company, and in many instances between project types within a single company. Thus, each tool maintains its own common store and individual mechanism of classification. The individual classification mechanisms and structures lead to user confusion due at least in part to the fact that they must understand the inner workings of many classification mechanisms.

Accordingly, there is a need in the art for a common classification system that allows a consistent set of structures across unrelated tools to facilitate a cohesive user experience.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention concerns a distributed object classification system and method. In particular, the invention provides a loosely-coupled way for unrelated tools to categorized elements they control according to a common, centrally-managed classification scheme. According to an aspect of the subject invention, the classification system also includes mechanisms for storing and retrieving classifying structures. For instance, structures can be instantiated by conforming to a structure type including such things as a node type, a structure type class, and structural constraints. In the end, users of tools employing the present classification system see a single consistent set of structures and enumerations across those tools thereby providing a foundation for a cohesive user experience.

Common classification of software and software related artifacts is vital to enabling an integrated experience over a federated suit of tools. The distributed classification of the subject invention is an innovative mechanism for achieving such common classification with minimal obligation on the owners of classifiable artifacts.

More specifically and in accordance with an aspect of the invention, mechanisms for building and maintaining one or more taxonomies are provided. To that end, a graphical user interface and associated APIs (Application Programming Interfaces) can be employed. For example, a user interface can be attached to a tool user interface or utilized separately to classify artifacts by dragging and dropping artifacts onto a classification node. Furthermore another interface helper component can by utilized to facilitate selection of a structure and/or classification nodes provided therein. According to another aspect of the invention, taxonomies can be defined automatically or semi-automatically by employing heuristics and statistical analysis associated with artificial intelligence.

According to yet another aspect of the present invention, a notification system is provided. The notification system can raise events to owners of classifiable artifacts, the consumers of the common classification structure, when charges are made or proposed. For instance, a before event can be raised to notify owners and give them an opportunity to review the change and either approve the change or veto the proposed change. Alternatively, an after change event can be raised to all customers to enable them to reflect that a change has been completed.

The distributed classification system and method of the subject invention provides a multitude of advantages. For instance, users have a single place to go to maintain common data structures like their project classifications. Additionally, any common data that can be expressed as a hierarchy or list can be maintained through one common mechanism.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of an distributed object classification system in accordance with an aspect of the present invention.

FIG. 2 is a schematic block diagram of a structure component in accordance with an aspect of the present invention.

FIG. 3 is a schematic block diagram of an exemplary classification meta model in accordance with an aspect of the subject invention.

FIG. 4 is a diagram of a portion of an exemplary project hierarchy in accordance with an aspect of the subject invention.

FIG. 5 is a diagram of a portion of an exemplary project hierarchy in accordance with an aspect of the subject invention.

FIG. 6a is an exemplary instance diagram in accordance with an aspect of the subject invention.

FIG. 6b is an exemplary instance diagram in accordance with an aspect of the present invention.

FIG. 7 is an exemplary instance diagram in accordance with an aspect of the subject invention.

FIG. 8 is an exemplary instance diagram in accordance with an aspect of the present invention.

FIG. 9 is an exemplary instance diagram in accordance with an aspect of the subject invention.

FIG. 10 is an exemplary structural hierarchy in accordance with an aspect of the present invention.

FIG. 11 is an exemplary graphical user interface in accordance with an aspect of the present invention.

FIG. 12 is an exemplary graphical user interface in accordance with an aspect of the subject invention.

FIG. 13 is an exemplary graphical user interface in accordance with an aspect of the present invention.

FIG. 14 is a schematic block diagram of an event monitoring system in accordance with an aspect of the present invention.

FIG. 15 is a schematic block diagram of a notification system in accordance with an aspect of the subject invention.

FIG. 16 is a flow chart diagram of a common classification methodology in accordance with an aspect of the subject invention.

FIG. 17 is a flow chart diagram of a common enterprise classification scheme methodology in accordance with an aspect of the present invention.

FIG. 18 is a schematic block diagram illustrating a suitable operating environment in accordance with an aspect of the present invention.

FIG. 19 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. For example, a computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope or spirit of the subject invention.

### Classification System

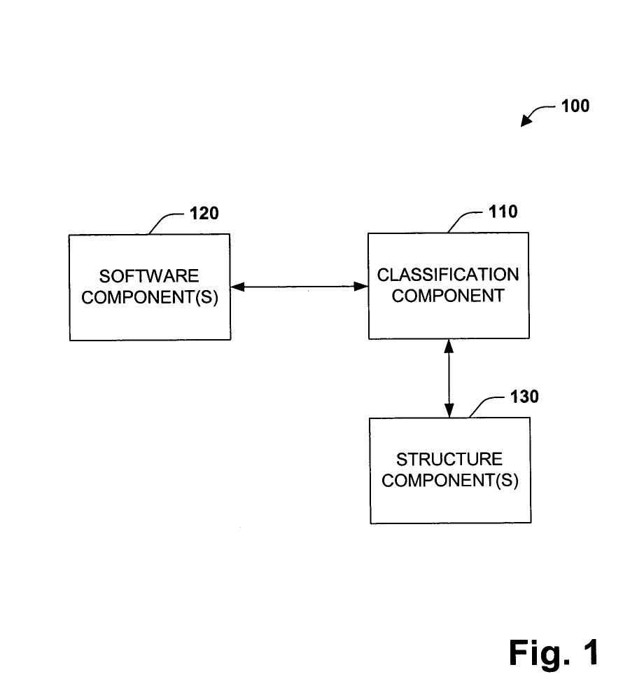

Turning initially to FIG. 1, a distributed object classification system 100 is depicted in accordance with an aspect of the subject invention. Classification system 100 comprises classification component 110, software component(s) 120, and structure component(s) 130. Classification component 110 receives or retrieves software component(s) 120. Software components(s) 120 can be any type of classifiable software artifact or persisted data worth keeping tabs on (e.g., file, object, image . . . ). Upon receipt of one or more software component(s) 120, the classification component generates and/or places software component(s) 120 into one or more structure component(s) 130. Classification component 110 can classify software component(s) 120 into structure component(s) 130 utilizing one or more or a combination of distinct mechanisms or methodologies. For example, software component(s) can be classified at the direction of a user employing graphical user interface. Additionally or alternatively, software components(s) can be classified automatically or semi-automatically utilizing a rule based expert system or other artificial intelligence technologies including but not limited to neural and Bayesian networks, and the like. Such classification can be based on a file name, type, and/or content to name but a few. Classification component(s) store software component(s) 120 in any reasonably organized fashion, however according to one aspect of the invention they are organized hierarchically.

Furthermore and in accordance with another aspect of the present invention, software component(s) 120 are commonly classified for use between and amongst a plurality of federated components. For instance, an enterprise development project includes a collection of tasks to be completed over time that results in the production of a set of software artifacts or components. The organization of an enterprise development project enables team members to communicate meaningfully about the state of a projects progress. It also provides a system of grouping software artifacts in some logical fashion. One significant problem is that this project classification hierarchy can vary from company to company and in many cases between project types within a company. Thus, enterprise customers require a flexible way to represent their common mental model for organizing their projects.

Because project classification hierarchies are so central to the organization of project artifacts, they should be shared by multiple tools. Without a common way to store and maintain this structure, each tool would be required to have its own mechanism of classification. Without sophisticated multi-way synchronization techniques, the various classification hierarchies would diverge leading to user confusion and a total lack of cohesion. Providing a common structure enables software component classification in a single place. However, not only do multiple artifacts share the same hierarchy, there are alternative structures that might apply to a single artifact. Take, for instance, a work item. It might be classified by a feature area, a breakdown that usually begins with some high-level organization and eventually is refined into broad components and groups of features. In one conventional application, this is the principal method of classification for bugs. Additionally, though, a user might want to assign some temporal classification to a work item.

The above description illustrates a more general characteristic of the present invention, namely it can be employed as a query point and maintain any hierarchical data that is common across a plurality of services and tools. If, for instance, a tool had a need to associate its artifacts to people in an organizational chart, the present invention could be utilized to hold and provide access to that organizational chart. Likewise, in defect tracking one might determine that they wish to allow users to change the names of various work items (e.g., an IT group in a marketing firm might want to change “defect” to “opportunity”). The present invention allows such customizations to be made easily.

Additionally, it is not true that all tools share the same classification schemes. For instance, while defect tracking, requirements management, and test case management may all use the same hierarchy, the source control system's classification scheme revolves around folder hierarchies and is under direct control of the source control system. While these two classification schemes may be similar, it is unreasonable to force them to be the same. However, that does not mean that various tools will not want to explore both hierarchies using the same services. For at least that reason, the present invention can include a provider model to enable external parties (e.g., source control) to expose their classification data.

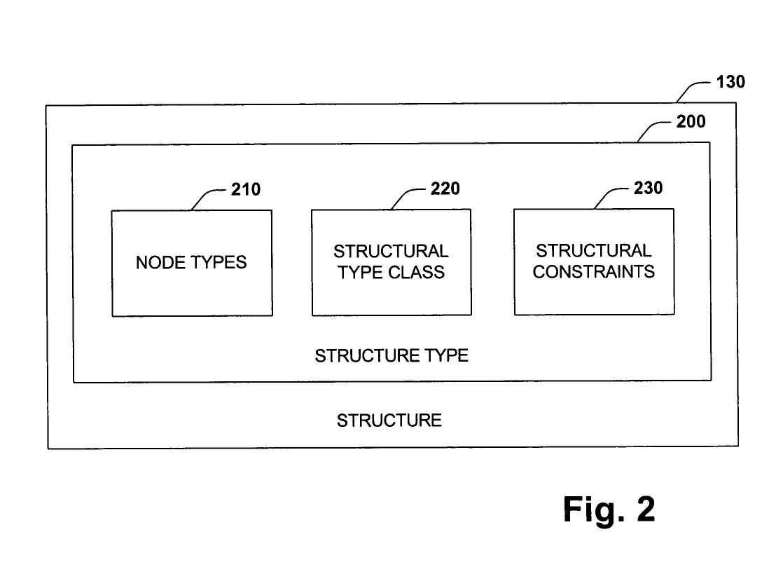

Turning to FIG. 2, a structure component 130 is illustrated in accordance with an aspect of the subject invention. Each structure component 130 can be of a particular type 200. Structure type component 200 or structure section, describes the pattern to which instances of nodes should conform. To that end, structure type component 200 includes node type 210, structure type class 220, and structural constraints 230. A node type 210 defines the kind of thing that can be included in a structure. For instance, a structure based on organizations might consist of a set of Divisions, Groups, Teams, and People. It's likely that one would want to carry different information about a Division (e.g., a division id) than about a Group, Team, or Person. Likewise, one might want to put some constraints on division that may not hold true for team. For example, one might not be able to divide a Division into sub-divisions. Instead, by definition, a Division divides into Groups. However, a Department might be decomposable into sub-departments. Each of the aforementioned distinctions, namely Division, Group, Team, and Person, can be a node type.

A structure type class 220 describes how a set of nodes of various node types can be assembled into a list or hierarchy. In the preceding example, for instance, one can imagine a kind of structure named “Organization Breakdown” that describes the rules for defining a hierarchy. One can further imagine that in a structure of that type the following statements should be true:
The top nodes in the structure should be Division.
Divisions may have both People and Groups as children.
Groups may have both People and Departments as children.
Departments may have both Teams and People as children.
Teams may have Teams (i.e., sub-teams) and People as children.

It is also possible that some of the same node types can be present in another structure type known as a “Feature Hierarchy.” In the Feature Hierarchy, imagine that the following node types are used: Group, Team, Component, and Feature Area. Note that the same node type definitions are used for Group and Team, but that Division and Department are missing because they are unimportant in the Feature Area hierarchy.

Structural constraint(s) 230 describe the permissible parent-child relationships between various node types 210. For instance, a node of type Organization Unit might be at the root and may be parent to more Organization Units. Eventually, an Organization Unit might decompose into Components or Feature Areas, neither of which can subsequently be the parent of an Organization Unit.

A structure 130 is an actual instance of a structure that conforms to a structure type 200. For instance, given the “Organization Breakdown” structure type, a structure based on that type in a plumbing supplies component might look something like:

```
Potable Water: Division
        - Thurman Talbott, Senior VP: Person
        - Installation: Group
            - Arden Snellbling, VP: Person
            - Copper Pipes: Department
                - Bert Nurnie, Department Head: Person
                - King County: Team
                    - Seattle: Team
                        - Anne Rice, Lead: Person
                        - Davey Talbott: Person
                        - Doogie Howser: Person
                    - Eastside: Team
                    ...
                - Snohomish Country: Team
                ...
            - Non-copper Pipes: Department
            ...
        -Maintenance: Group
        ...
- Non-potable Water and Sewage Treatment: Division
    ...
```

The bold entries refer to the node type 210 of each node. The structure also conforms to the constraints as described supra for the Organizational Breakdown structure type.

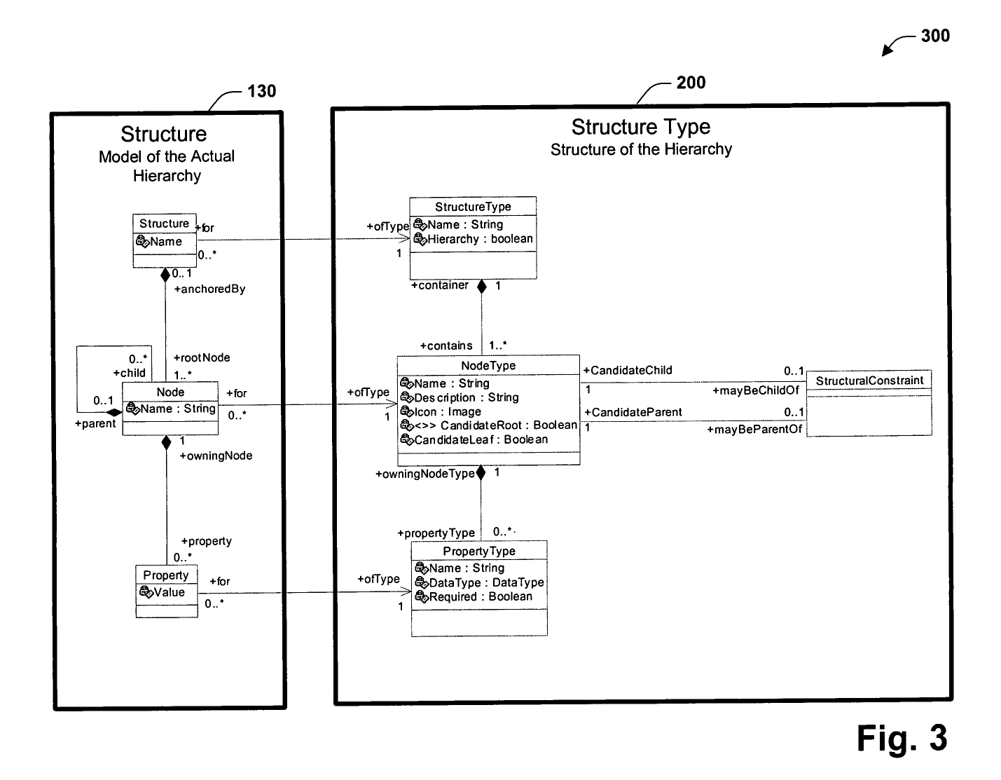

FIG. 3 illustrates an exemplary classification meta model 300 in accordance with an aspect of the subject invention. The classification meta model 300 illustrates various concepts involved in a structure and the relationships between them. This model is provided for purposes of clarity and understanding and is not meant to limit the scope of the present invention in any manner. Those of skill in the art upon reading this specification will appreciate a multitude of different variations of the model, which are all considered within the scope of the subject invention. In order to make sense out of the model it is helpful to break it into two sections or components: the structure type component 200 and the structure component 130. To facilitate description and for purposes of clarity the following sections use an abbreviated notation for describing navigation through instances of the model 300. In particular, the convention is to use role names (e.g., the names on the lines that are preceded by “+”) and attribute names (e.g., the names of the things inside boxes) to form an expression that describes a navigation path. For example, imagine that you need to navigate from an instance of a node class to its parent node to find out what the name of its parent node's node type is. The following expression says exactly that in an efficient manner:
Node.parent.ofType.Name
This terse rendering can be interpreted as follows. First, start at some node. From that node, follow the node at the end of the association that has a +parent role, that is navigate to the node's parent. Thus, so far we have: Node.parent. Now, starting from the newly discovered parent node, navigate to its node type. This can be accomplished by following the association between node and node type. The role name to follow here is “ofType. Now we have: Node.parent.ofType. Finally, once on the parent node type instance, you have to return the name attribute. Here it is some string. Sometimes for the sake of clarity, an expression can include the name of the class to which a role points indicated in an expression. When this is done, the role can be separated from its type name with a colon, as follows:
Node.parent:Node.ofType:NodeType.Name.
Furthermore, the types of attributes can be tacked on, as here:
Node.parent:Node.ofType:NodeType.Name:String

The following section describes details of attribute, associations, and rules in which meta model classes participate. It is divided into two sections: Structure Type and Structure.

### Structure Type

In the Structure type section, the kinds of hierarchies that can be formed by combining node types in various ways are defined. As previously mentioned, a structure type section or component can include three types: structure type class, node type, and structural constraint. The structure type class holds the name of the structure type and identifies whether or not it is a hierarchy. Examples of structure type class include Organizational Hierarchy, Feature Area Hierarchy, Release Hierarchy, and Work Item Status Types. The node type defines the kind of thing that will be in a structure. Examples of node types include Organization Unit, Component, Feature Area and Milestone. For each Node based on a node type, certain information can be present, such as name and description. Structural constraints describe the permissible parent-child relationships between various node types. For example, a node of type Organization Unit might be at the root and may be the parent to more Organization Units. Eventually, an Organization Unit might decompose into Components or Feature Areas, neither of which can subsequently be the parent of an Organization Unit.

Structure type class can further be defined by the following attributes and associations:

Attributes

| | |
|---|---|
| Name: String | The name of the structure type. Must be unique. |
| IsHierarchy: | If true, this structure type represents a hierarchical |
| Boolean | arrangement of nodes. If false, this structure type |
| | represents a flat list. |
| | Note: The value of this attribute can actually be |
| | determined by the absence of StructuralConstraint |
| | instances (which describe permissible parent-child |
| | relationships.) However, it seemed important to |
| | explicitly distinguish between a hierarchy and a list. |

Associations

| | |
|---|---|
| contains: | The NodeTypes defined for this structure type . . . |
| NodeType [1 . . . *] | |
| for: Structure | Each specific Structure should be defined by a |
| [0 . . . *] | Structure Type. |

Node type can be further defined by the following attributes and associations:

Attributes

| | |
|---|---|
| Name: String | The name of the node type should be unique. |
| | Examples: |
| | Organization Unit |
| | Component |
| | Feature Area |
| | Milestone |
| Description: String | Optional node type description. |
| Icon: Image | The default icon that appears in tree controls when a node |
| | of this type is displayed. |

Attributes

| | |
|---|---|
| CandidateRoot: Boolean | Indicates whether nodes of the referenced type (type: |
| | NodeType) can appear as top-level nodes in the hierarchy. |
| CandidateLeaves: Boolean | Indicates whether nodes of the referenced type (type: |
| | NodeType) can appear as lowest-level nodes in the |
| | hierarchy. |

Associations

| | |
|---|---|
| container: | Each NodeType is owned by a StructureType. |
| StructureType [1] | |
| for: Node [0 . . . *] | Each node points to its corresponding node type. |
| mayBeParentOf: | The navigation path |
| StructuralConstraint | Node Type.mayBeParentOf.CandidateChild.type: NodeType indicates that a |
| [0 . . . *] | node of the first NodeType can be the parent of a node of the second |
| | NodeType. |
| | This association is used to constrain the nodes that can appear in an actual |
| | Structure. |
| mayBeChildOf: | The navigation path |
| StructuralConstraint | NodeType.mayBeChildOf.CandidateParent.type: NodeType indicates that a |
| [0 . . . *] | node of the first NodeType can be the child of a node of the second |
| | NodeType. |
| | This association is used to constrain the nodes that can appear in an actual |
| | Structure. |

Structural constraints can be further defined as follows:

Associations

| | |
|---|---|
| CandidateParent: NodeTypeUsage [1] | Paired with CandidateChild, describes the potential |
| | for nodes of the NodeType's to be parents of nodes |
| | of the candidateChild's NodeType's. |
| CandidateChild: NodeTypeUsage [1] | See above. |

### Structure

This section describes the actual instance of nodes. The present invention governs the composition and content of these based on the definitions of related node type and structure type class. The following provides details regarding structure attributes and associations:

Attributes

| | |
|---|---|
| Name: String | The name of the structure. Should be unique but may have |
| | the same name as its StructureType. |
| Description: String | A description of the structure. Appears as a tooltip. |

Attributes

| | |
|---|---|
| IsDistinguished: Boolean | Indicates whether a tool wants to treat this structure as its |
| | Distinguished Hierarchy |

Associations

| | |
|---|---|
| ofType: StructureType [1] | Identifies the StructureType that describes the |
| | constraints to which this Structure may belong. |
| rootNode: Node [1 . . . *] | The set of top-level nodes in this structure. Note |
| | that this hierarchy does not have a single root node. |

What follows is a detail specification of attributes and associations
for nodes.
Attributes

| | |
|---|---|
| Name: String | Each node should be uniquely named among all of its siblings. |

Associations

| | |
|---|---|
| anchoredBy: Structure [0 . . . 1] | Each top-level node is directly associated with |
| | Structure via anchoredBy. |
| parent: Node [0 . . . 1] | Identifies the parent of the node. |

### EXAMPLE

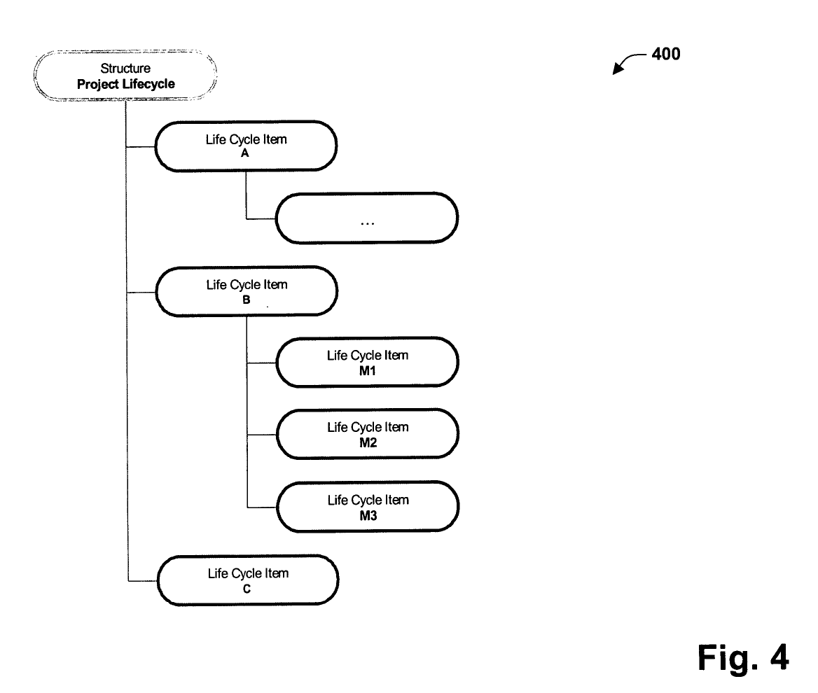

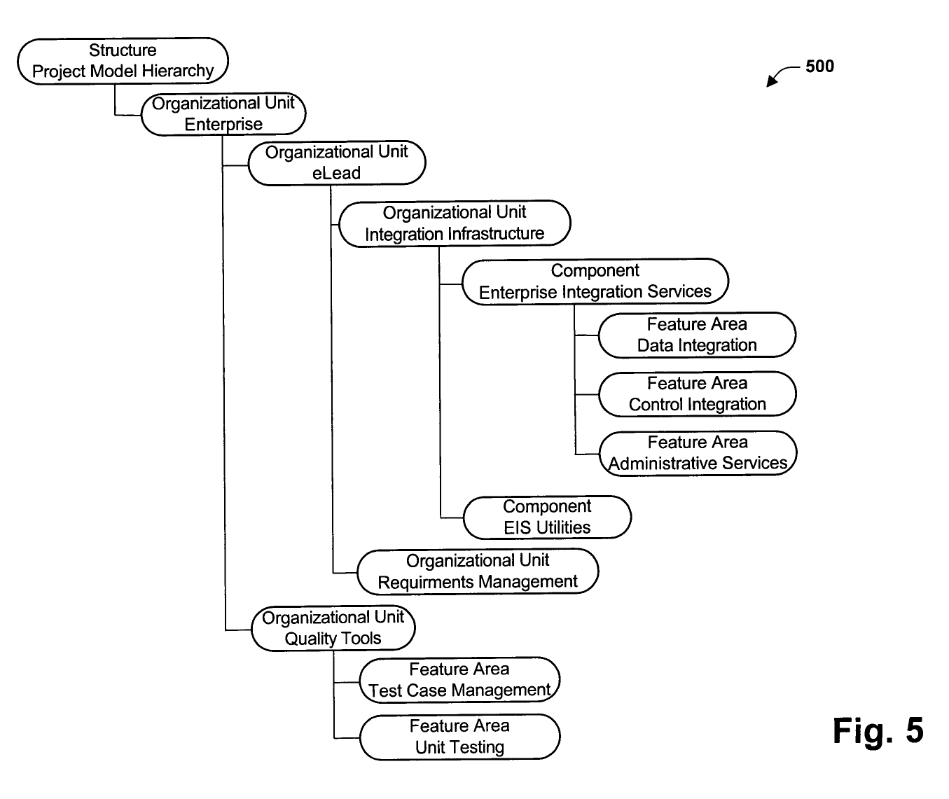

The following example utilizes instance diagrams to illustrate how specific instances of the classes described in the preceding sections are employed to represent a structure. To start, assume that we want two structures (FIGS. 4-5) organized as follows:
1. Project Lifecycle hierarchy that is made up of a set of decomposing Life Cycle Item nodes. FIG. 4 illustrates an example of part of a Project Lifecycle hierarchy 400.
2. A Project Model hierarchy that involves nodes of three types: (a) Organizational Unit; (b) Component; and (c) Feature Area.
3. The relationships between the nodes of various types in the Project Hierarchy follow these rules:
   a. The top nodes in the hierarchy should be Organizational Units.
   b. Each child of an Organizational Unit can be one of the following:
      i. A subordinate Organizational Unit;
      ii. A Component; or
      iii. A Feature Area.
   c. Each child of a Component can be either:
      i. A subordinate Component; or
      ii. A Feature Area.
   d. Each child of a Feature Area can be either:
      i. A subordinate Component; or
      ii. A Component.
   e. In this example, none of the nodes are obliged to have children. In other words, the decomposition can stop with an Organizational Unit, a Component, or a Feature Area.
      FIG. 5 illustrates an exemplary portion of the Project Model hierarchy 500 in accordance with the present example.

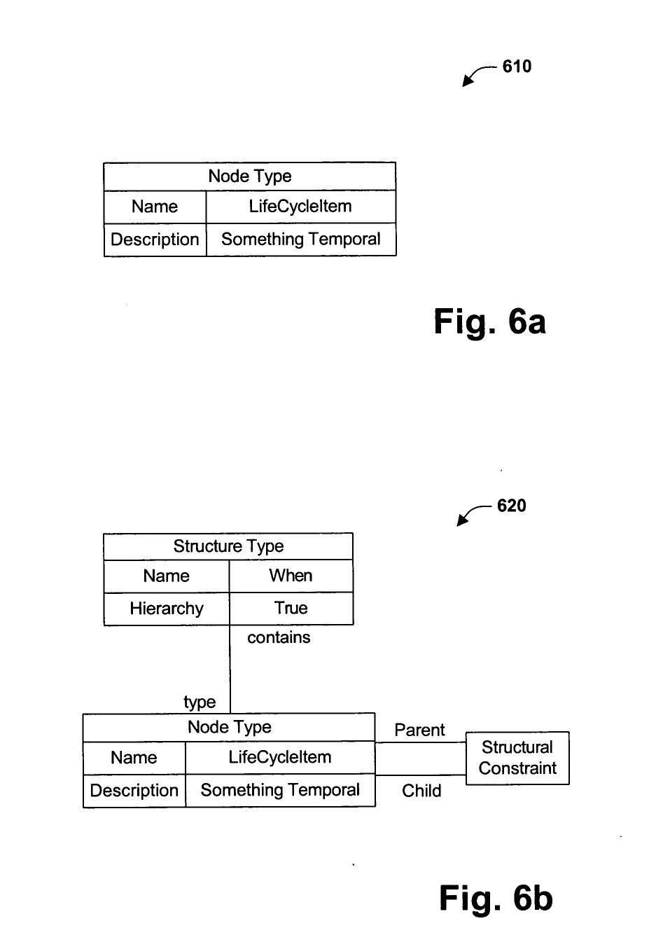

The present example involves two structures (i.e., Project Lifecycle and Project Model Hierarchy), each of which has a different set of allowable node types. Thus, a structure type needs to be defined for each structure to specify which kinds of nodes a customer can enter into the structure and the parent-child relationships in which such nodes can participate. Turning first to FIG. 6a, an instance diagram 610 is depicted. For the Project Lifecycle structure, there is a single node type called LifeCycleltem. Accordingly, the instance diagram 610 shows the name and description for the single node type, here something temporal.

To define how nodes of this type can be assembled to form a hierarchy, a structure type class is required. On the eLead team, a hierarchy made up of temporal nodes is dubbed a “When” hierarchy so the structure type class can be called “When.” FIG. 6b illustrates instances that compose the When structure type class. Although not shown in the figure, assume that the attributes CandidateRoot and CandidateLeaf are set to true. This indicates that when the user builds a structure based on the When structure type she can have a node based on LifeCycleItem at both the top and the bottom of the hierarchy. The structural constraint hanging from the node type LifeCycleItem indicates that the structural constraint can be the parent of a LifeCycleItem and that a LifeCycleItem can be the child of a LifeCycleltem. In other words, the hierarchy is a tree LifeCycleItems

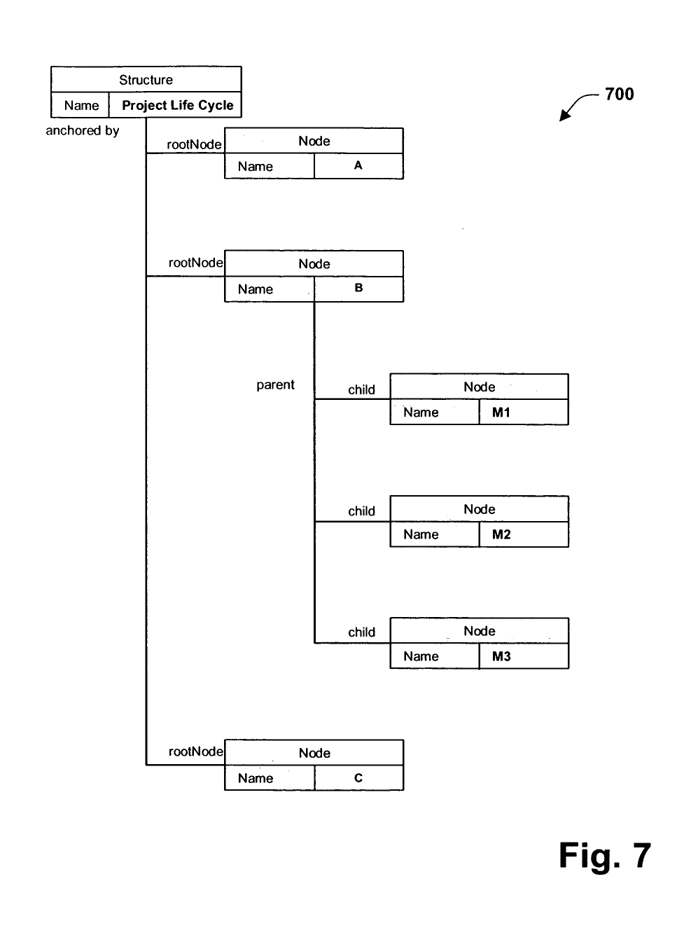

Turning to FIG. 7, an instance diagram 700 is illustrated. Instance diagram 700 depicts the specific instances that make up the Project lifecycle structure illustrated by FIG. 4. The Project Lifecycle structure is based on the “When” structure type. FIG. 7 is fine as far as it goes, but it does not show the specific types of Structure or Node involved on which the structure and nodes in this diagram are based. That is, there is no way to tell from this instance that the node labeled “A” is a LifeCycleItem.

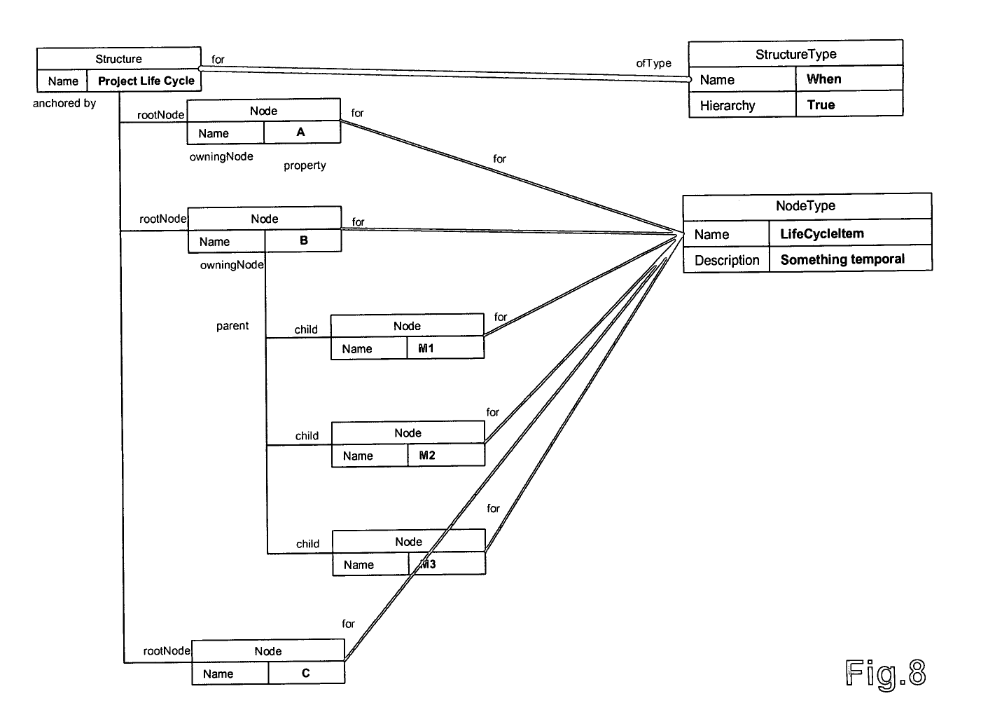

FIG. 8 depicts yet another instance diagram 800 in accordance with an aspect of the subject invention. In order to understand which nodes are which the instance diagram 700 (FIG. 7), the Project Life cycle structure must be mapped to the instance diagram 620 (FIG. 6b) that defines the When structure type class. The mapping is illustrated in instance diagram 800. It should be appreciated that for readability, the think line represents an instance of the association Structure.ofType:StructureType and the thinner lines represent instances of the association Node.ofType:NodeType. The diagram is pretty straightforward in this very small model where there is only one node type. However, the importance of the constraints represented by the structure type model becomes clearer when the model is more complex as in the case of the Project Model Hierarchy.

The Project Model Hierarchy involves three node types: Organizational Unit, Component, and Feature Area. A structure that starts off as an organization hierarchy and morphs into feature areas and components as it is decomposed can be informally called a Who/Where structure. Thus, the structure type class on which this structure is based WhoWhere.

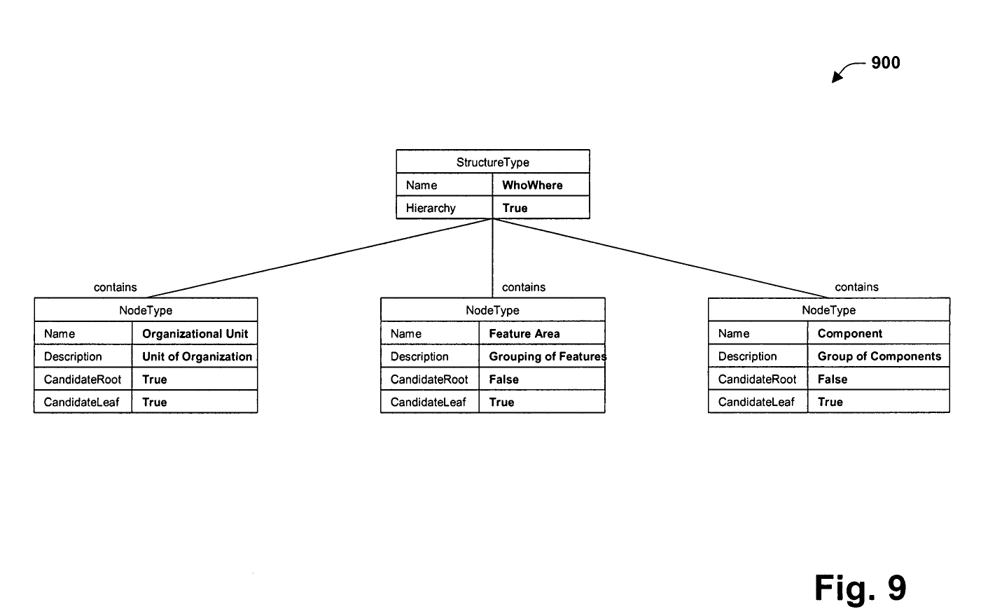

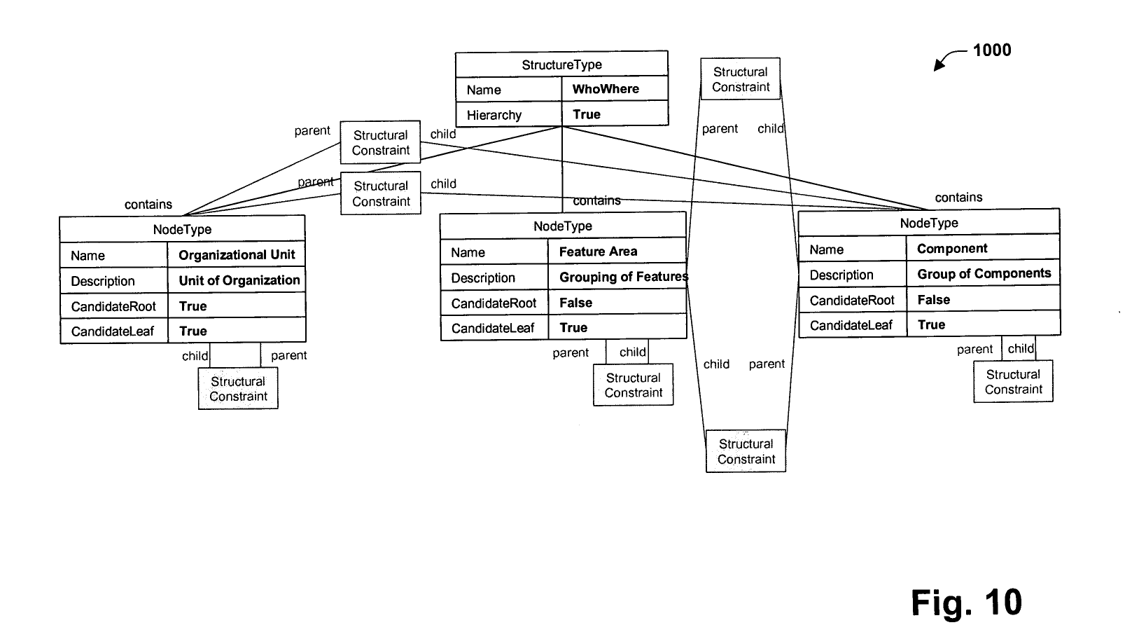

Turning to FIG. 9, an instance diagram 900 is illustrated. The diagram 900 illustrates fundamental elements of the WhoWhere hierarchy, but something is missing. It is possible from the diagram to determine that Organizational Unit nodes can be at the top of the hierarchy and that Feature Areas and Components cannot be based on the value of their respective CandidateRoot properties (NodeType.CandidateRoot). However, it says nothing about whether an Organizational Unit can contain a Feature Area (which is allowed) or whether a Feature Area can contain an Organizational Unit (which is not allowed). This additional constraint is specified by introducing Structural Constraint instances that define who can be the parent of whom. This clutters the model up a bit, but is extremely flexible. Turning briefly to FIG. 10, a structural hierarchy 1000 is illustrated. Structural hierarchy 1000 describes all the constraints on the Project Model Hierarchy previously mentioned. Furthermore, structural constraints are illustrated specifying parent and child relationships amongst type nodes.

### User Interfaces and the Meta Model

There are at least two distinct kinds of users of the common structures of the present invention. The first and most common is an end user of common structures. The second is a structure administrator. This section deals with each of these types of users in turn.

Furthermore, it should be appreciated that there are a myriad of environments from which an end user and an administrator might interact with common structures. For example, a user can interact with common structures via a Web environment. Additionally or alternatively, a user can interact with common structures within other applications such as a programmatic shell environment (e.g., Microsoft's Visual Studio) or other less rich client.

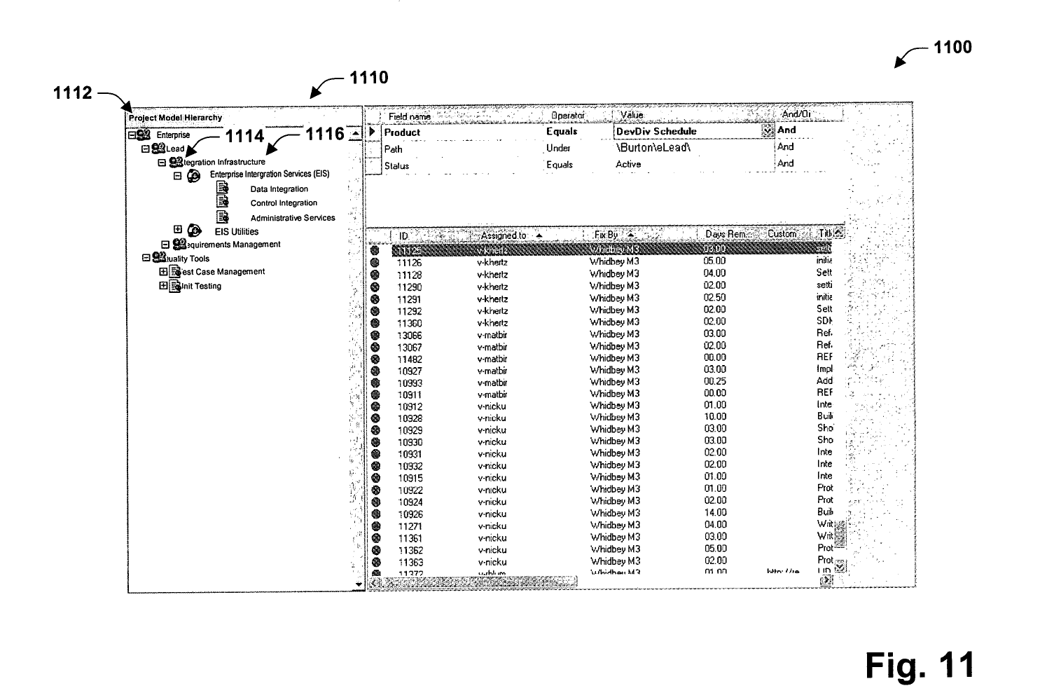

Turning to FIG. 11, an exemplary graphical user interface 1100 is illustrated in accordance with an aspect of the present invention. The interface 1100 depicts a common structure interface 1110 embedded or integrated into a defect-tracking tool. As shown, the common structure interface 1110 is a single windowpane amongst many other windowpanes in a graphical display. The name of the structure (e.g., structure.name), here Project Model Hierarchy, is provided in a title bar 1112. Nodes associated with the particular structure can then be graphically represented and organized in a hierarchy. Furthermore, each node in the hierarchy can be displayed with an associated icon and/or node string to facilitate node identification. Additionally, nodes can be indented, as in most hierarchical representations, to indicate child association. For instance, Data Integration, Control Integration, and Administrative Services are all child nodes of Enterprise Integration Services. Thus, an end-user does not have to view the common structures as independent constructs at least because each such structure can be integrated into the overall user experience of tools that reference it.

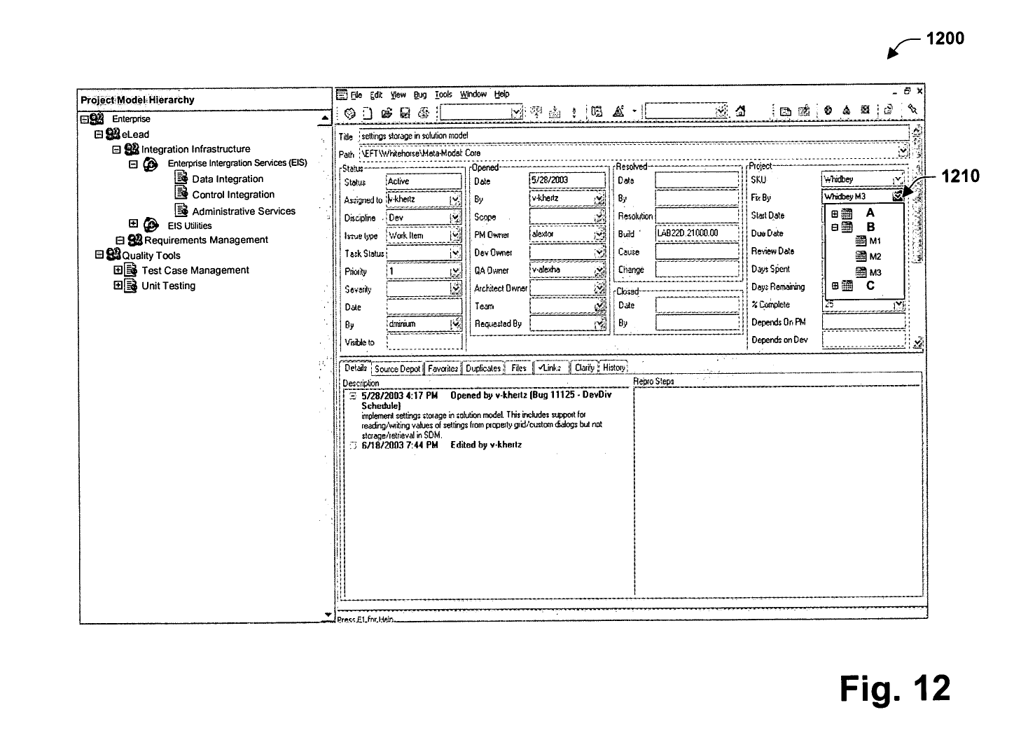

FIG. 12 depicts another exemplary graphical user interface 1200 incorporating common structures. Here, another bug tracking system interface 1200 is illustrated. However, in this instance a user interface helper control 1210 is shown. The user interface helper control 1210 can be employed to facilitate selection of a classification node from within the bug tracking user interface. The interface helper control 1210 can include one or more of a plurality of graph components (e.g., icons, text, boxes, buttons, tabs . . . ). Here, interface helper control 1210 is shown as a drop down menu.

The graphical interface components in FIGS. 11 and 12 provide exemplary means of interaction with common structures. Such interaction can include viewing structures, adding nodes, renaming nodes and deleting nodes. In one instance, structure nodes can be explored utilizing a tree as in FIG. 11. Furthermore, the interface components can be used to attach something to a node in a structure, for instance, by dragging and dropping either to of from a node on the tree view. For example, a requirement might be mapped to a node in a structure by dropping the requirement onto the structure. Additionally or alternatively a drop-down menu can be employed as in FIG. 12. In such case, something can be attached to a node in a common structure by selecting from the drop-down menu. Furthermore, it should be appreciated that a role-base filter can be applied to restrict a user's view to a particular set of nodes. This is useful for scoping a user's view to a specific project or application in which he or she is interested.

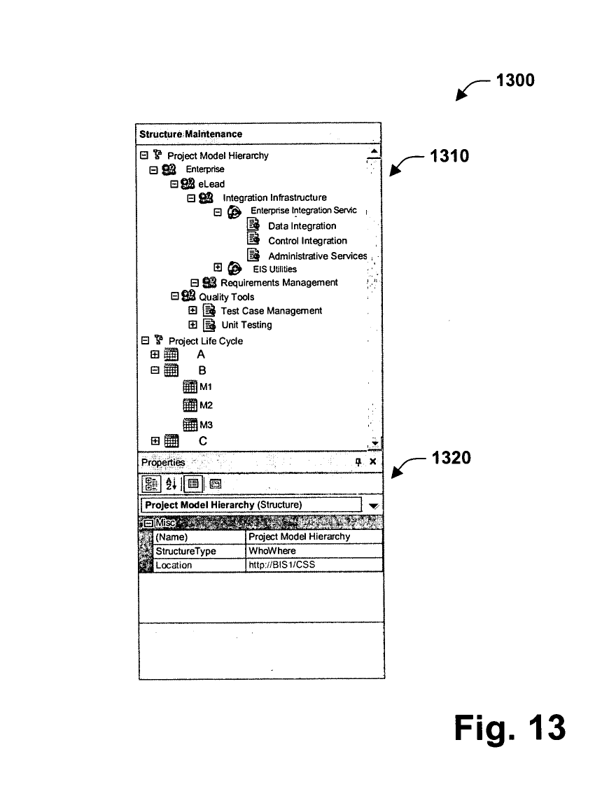

Turning to FIG. 13, a structure maintenance tool 1300 is illustrated in accordance with an aspect of the subject invention. An administrator can modify structures by adding, changing, or deleting nodes by using a structure maintenance tool 1300. The tool 1300 can include a tree section 1310 and a properties section 1320. As illustrated, the exemplary administrator maintenance interface tool appears similar to the end-user tree view, however it contains some subtle and some not so subtle differences that make it a powerful ally to a beleaguered administrator. In particular, all structures are shown in the structure maintained tool bar in the tree section 1310. Furthermore, properties section 1320 provides more specific information regarding structures and nodes. Additionally, it should be appreciated that the structure maintenance tool 1300 can enable authorized users to add new structures and/or nodes.

### Common Structure Representation

The structures of the present invention are common structures intended for use by a multitude of similar or varying components and subcomponents. As a result and in accordance with an aspect of the invention, the common structures can be exposed to consumers and manipulators as XML (eXensible Markup Language) documents. Furthermore, in order to make XML documents more accessible to users they can be typed. That is to say, instead of seeing XML elements with tags of the general types node, node type, and property type a consumer will see nodes that are typed according to their structure type. For example:

```
<ProjectModelHierarchy type=“WhoWhere”>
    <OrganizationalUnit NodeID=“immutable001” >
        <Name>Enterprise</Name>
        <OrganizationalUnit NodeID=“immutable002” >
            <Name>eLead</Name>
            <OrganizationalUnit NodeID=“immutable003” >
                <Name>IntegrationInfrastructure</Name>
                <Component NodeID=“immutable004” >
    <Name>EnterpriseIntegrationServices</Name>
                    <FeatureArea Node ID=“immutable005”>
                        <Name>DataIntegration</Name>
                    </FeatureArea>
                    <FeatureArea NodeID=“immutable006” >
                        <Name>ControlIntegration</Name>
                    </FeatureArea>
                    <FeatureArea NodeID=“immutable007” >
                        <Name>AdministrativeServices</Name>
                    </FeatureArea>
                </Component>
                <Component NodeID=“immutable008” >
                    <Name>BISUtilities</Name>
                </Component>
            </OrganizationalUnit>
            <OrganizationalUnit NodeID=“immutable009” >
                <Name>RequirementsManagement</Name>
            </OrganizationalUnit>
        </OrganizationalUnit>
        <OrganizationalUnit NodeID=“immutable010” >
            <Name>Quality Tools</Name>
            <FeatureArea NodeID=“immutable011” >
                <Name>TestCaseManagement</Name>
            </FeatureArea>
            <FeatureArea NodeID=“immutable012” >
        <Name>UnitTesting</Name>
            </FeatureArea>
        </OrganizationalUnit>
    </OrganizationalUnit>
</ProjectModelHierarchy>
```

### Event Monitoring and Notification

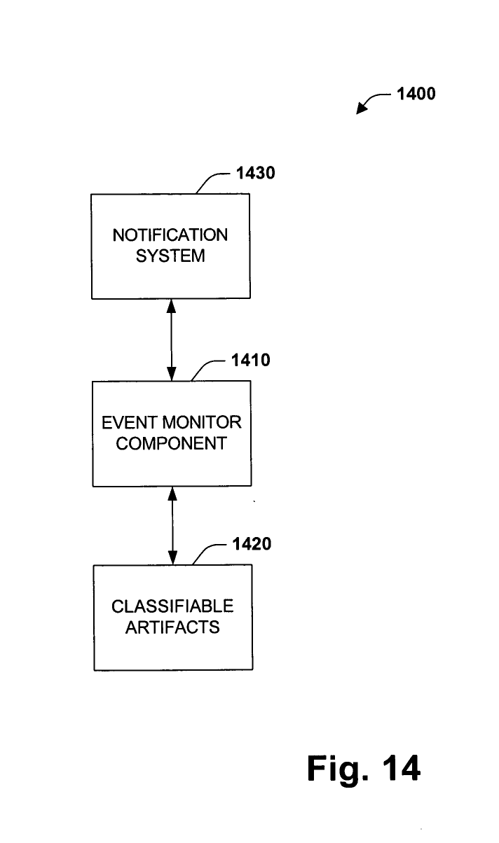

Turning to FIG. 14, an event monitoring system 1400 is described in accordance with an aspect of the subject invention. Event monitoring system 1400 comprises event monitor component 1410, classifiable artifacts 1420 and notification system 1430. Once a common structure has been established it can be monitored for events such as additions, deletions, and other manipulations thereto. Classifiable artifacts 1430 are pieces of data worth keeping track of which can also be classified. Monitor component 1410 monitors classifiable artifacts for changes. Upon detection of a valid alteration, such information can be passed to notification system 1430 to notify one or more designated parties.

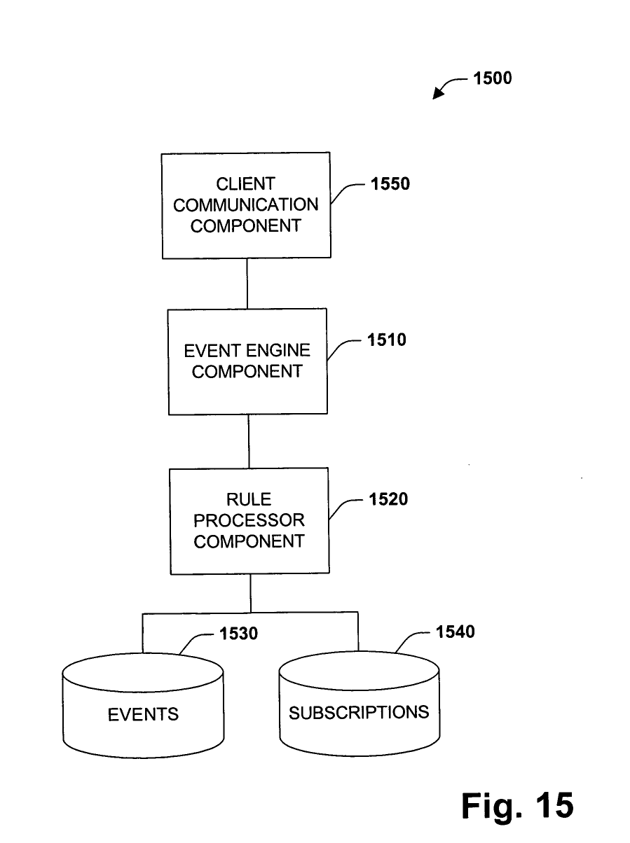

FIG. 15 illustrates a notification system 1500 in accordance with an aspect of the present invention. Notification system 1500 comprises event engine component 1510, rule processor component 1520, event store 1530, subscription store 1540, and client communication component 1550. Event engine component 1510 receives information concerning a change to a structural artifact. Thereafter, event engine component 1510 can then utilize event store 1530 to classify the occurrence. Then it can match the event to the subscriptions residing in subscription store 1540. Subscriptions can contain notification information such as whether to alert or not, who to notify (e.g., person, group, role), and preferred means of notification (e.g., email, pager, personal digital assistant . . . ). If a notification-worthy event occurs that matches a subscription, notification data can be provided to client communication component 1550. Client communication component 1550 provides a mechanism for notifying a user of an event. For example, communication component 1550 can push the message to a user's email. Additionally or alternatively, the notification message could be pulled from a location by a user or user device.

Furthermore, the subject invention also contemplates providing notification prior to affecting a change to the classification structure. For example, a before change event can be raised to all consumers of the structure to give them and opportunity to veto the change or approve the change. Additionally or alternatively, an after change event can be raise to all consumers to enable them to reflect a change that has bee committed. For instance they can ensure that any artifact that refers to a node id is still valid.

### Methodologies

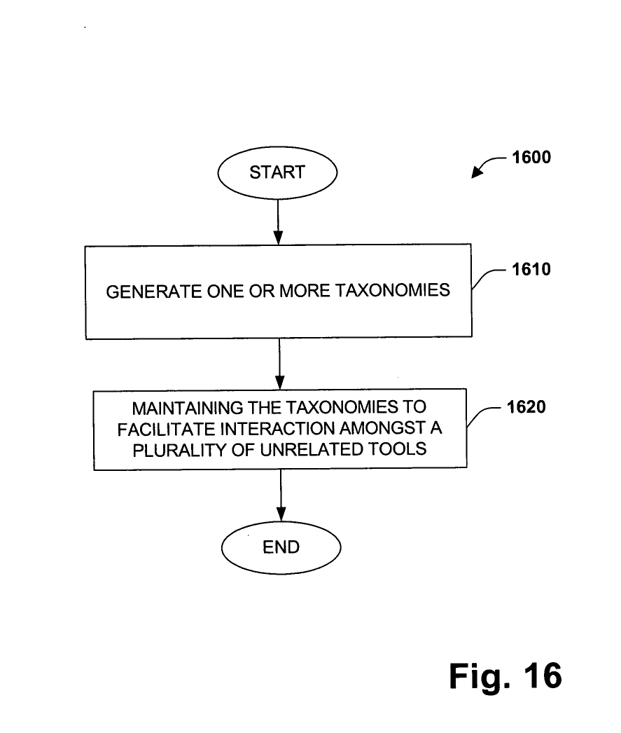

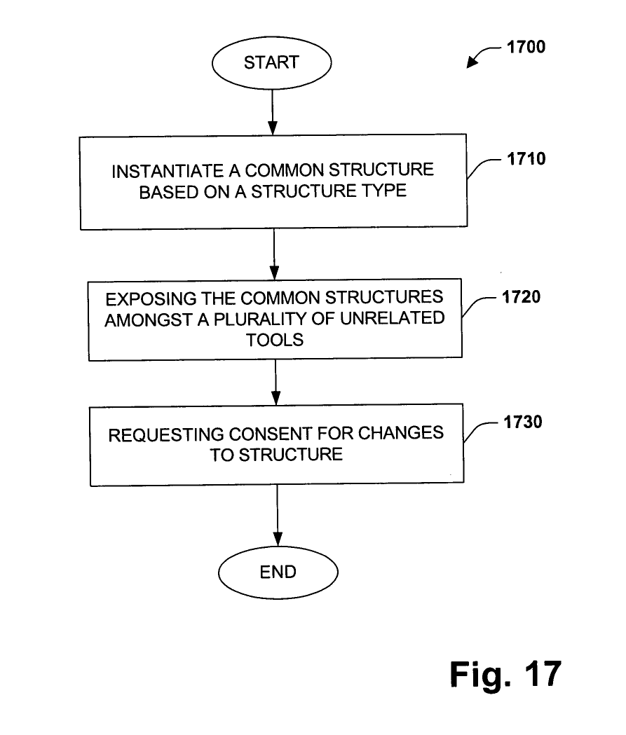

In view of the exemplary system(s) described supra, a methodology that may be implemented in accordance with the present invention will be better appreciated with reference to the flow charts of FIGS. 16-17. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media. By way of illustration and not limitation, the article of manufacture can embody computer readable instructions, data structures, schemas, program modules, and the like.

FIG. 16 illustrates a common classification methodology 1600 in accordance with an aspect of the present invention. At 1610 one or more taxonomies or structures are generated. These structures can include a myriad of globally unique and immutable nodes. The actual process of generating a taxonomy can comprise defining node types and structure type classes. A node type can specify the kind of thing included in a structure. For example, as structure might include Divisions, Groups, Teams, and People. A structure type class describes how a set of nodes of various node types can be assembled into a list or hierarchy. For example, the top nodes in the structure must be Divisions. Furthermore, generating a taxonomy can comprise defining structural constraints defining parent child relationships and more specifically who can be the parent of whom. The actual generation of the taxonomy can be achieved in several ways. First, a user or administrator can define the taxonomy utilizing a graphical interface. For instance, a user can drag and drop software artifacts on to classification nodes. Additionally, it should be appreciated that a user can import a taxonomy from a source. Still further yet, it should be noted and appreciated that heuristics and statistical analysis, such as those involved in artificial intelligence, can be utilized alone or in conjunction with other methods to generate a common classification taxonomy. At 1620, the classification is maintained to facilitate interaction with taxonomy artifacts by a plurality of unrelated tools. One manner of maintaining the taxonomy includes providing consumers of the taxonomy notification of a proposed change thereto so as to provide the consumer an opportunity to object. Furthermore, notification can be provided to consumers when changes are actually made or are about to be made so that they can compensate for the change to ensure reliable operation. For example, a classification consumer can ensure that any artifact that refers to a node id is still valid. Because node id is immutable according to an aspect of the invention, in most cases an artifact provider will not be affected unless a node is deleted. Hence, the methodology 1600 provides a way for unrelated tools to categorize elements they control according to a common centrally managed classification taxonomy. To that end, it should be appreciated that the taxonomy can be specified in XML (eXtensible Markup Langauge) to facilitate use and interpretation by differing and unrelated tools.

FIG. 17 is a flow chart diagram illustrating an enterprise classification scheme methodology 1700 in accordance with an aspect of the present invention. At 1710 a common structure is instantiated base on a structure type. A structure is an actual instance of a structure that conforms to a structure type. The structure type can be defined by node type, structure type class, and structural constraints. As mentioned supra, a node type defines the kind of thing you can include in a structure. A Structure type class defines how a group or set of nodes can be combined in a hierarchy, for example, while the structural constraints define which nodes can be the parent of which nodes. At 1720, the common structures can be exposes amongst a plurality of unrelated tools. Furthermore, the common structures can be exposed to users via a graphical user interface and associated API (Application Programming Interface). Finally, at 1730, consent can be requested of structure consumers to proposed changes in the structure. This gives consumers time to review the proposed change before it is committed and possibly object.

### Sample Operating Environments

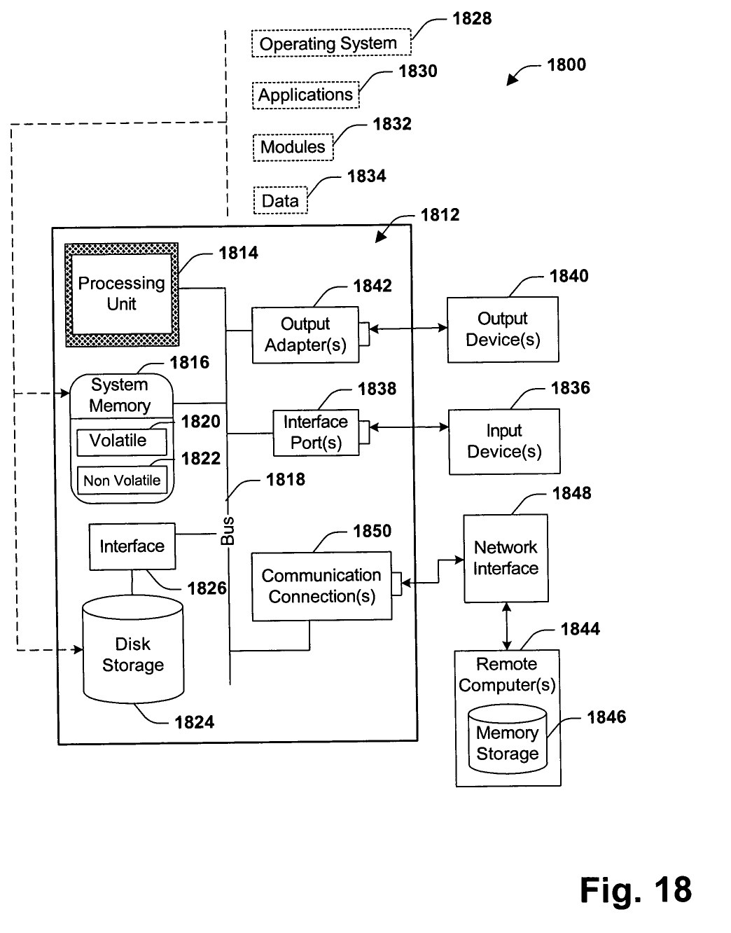

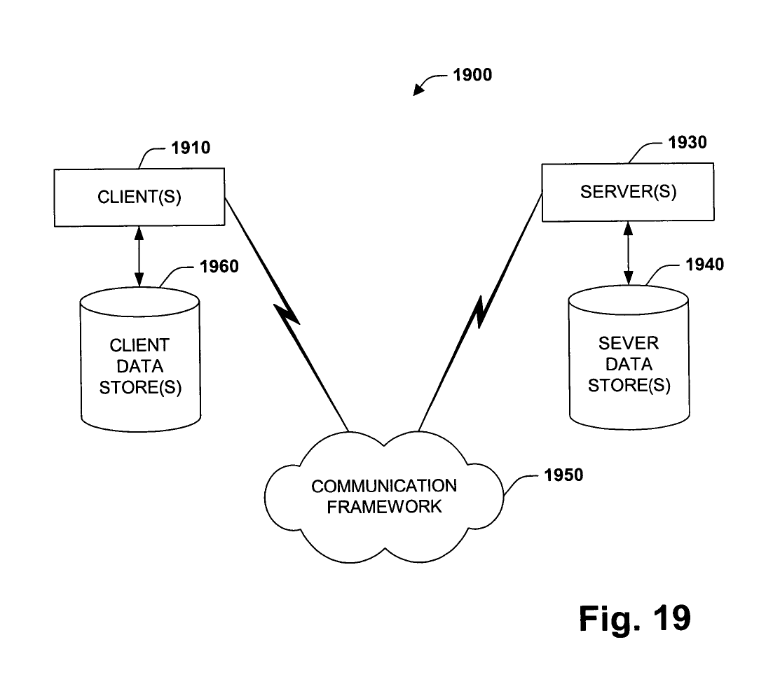

In order to provide a context for the various aspects of the invention, FIGS. 18 and 19 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 18, an exemplary environment 1810 for implementing various aspects of the invention includes a computer 1812. The computer 1812 includes a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814.

The system bus 1818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1816 includes volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable ROM (EEPROM), or flash memory. Volatile memory 1820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1812 also includes removable/non-removable, volatile/non-volatile computer storage media. FIG. 18 illustrates, for example disk storage 1824. Disk storage 4124 includes, but is not limited to, devices like a magnetic disk drive, floppy disk drive, tape drive, Jaz drive, Zip drive, LS-100 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to the system bus 1818, a removable or non-removable interface is typically used such as interface 1826.

It is to be appreciated that FIG. 18 describes software that acts as an intermediary between users and the basic computer resources described in suitable operating environment 1810. Such software includes an operating system 1828. Operating system 1828, which can be stored on disk storage 1824, acts to control and allocate resources of the computer system 1812. System applications 1830 take advantage of the management of resources by operating system 1828 through program modules 1832 and program data 1834 stored either in system memory 1816 or on disk storage 1824. Furthermore, it is to be appreciated that the present invention can be implemented with various operating systems or combinations of operating systems.

A user enters commands or information into the computer 1812 through input device(s) 1836. Input devices 1836 include, but are not limited to, a pointing device such as a mouse, trackball, stylus, touch pad, touch screen, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port may be used to provide input to computer 1812 and to output information from computer 1812 to an output device 1840. Output adapter 1842 is provided to illustrate that there are some output devices 1840 like monitors, speakers, and printers, among other output devices 1840 that require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a personal computer, a server, a router, a network PC, a workstation, a microprocessor based appliance, a peer device or other common network node and the like, and typically includes many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refers to the hardware/software employed to connect the network interface 1848 to the bus 1818. While communication connection 1850 is shown for illustrative clarity inside computer 1812, it can also be external to computer 1812. The hardware/software necessary for connection to the network interface 1848 includes, for exemplary purposes only, internal and external technologies such as, modems including regular telephone grade modems, cable modems, DSL modems, power modems, ISDN adapters, and Ethernet cards.

FIG. 19 is a schematic block diagram of a sample-computing environment 1900 with which the present invention can interact. The system 1900 includes one or more client(s) 1910. The client(s) 1910 can be hardware and/or software (e.g., threads, processes, computing devices). The system 1900 also includes one or more server(s) 1930. The server(s) 1930 can also be hardware and/or software (e.g., threads, processes, computing devices). The servers 1930 can house threads to perform transformations by employing the present invention, for example. One possible communication between a client 1910 and a server 1930 may be in the form of a data packet adapted to be transmitted between two or more computer processes. The system 1900 includes a communication framework 1950 that can be employed to facilitate communications between the client(s) 1910 and the server(s) 1930. The client(s) 1910 are operably connected to one or more client data store(s) 1960 that can be employed to store information local to the client(s) 1910. Similarly, the server(s) 1930 are operably connected to one or more server data store(s) 1940 that can be employed to store information local to the servers 1930.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes or having” is used in either the detailed description or the claims, such term is intended to be inclusive in a manner similar to the term “comprising” as “comprising” is interpreted when employed as a transitional word in a claim.

1. A distributed classification system, comprising:
a plurality of software components; and
a classification component that couples software components to a common classification structure.

2. The system of claim 1, the classification structure comprising node types and structural constraints.

3. The system of claim 2, wherein the classification structure is hierarchical.

4. The system of claim 1, wherein the software components are associated with classification nodes.

5. The system of claim 4, wherein a classification node comprises a globally unique identifier.

6. The system of claim 4, wherein a graphical user interface is employed by a user to classify software components.

7. The system of claim 6, wherein a user drags and drops components onto a classification node.

8. The system of claim 1, wherein the classification component utilizes heuristics and statistical analysis related to artificial intelligence to couple software components to the common structure.

9. The system of claim 1, further comprising a notification component that notifies consumers of the common structure of proposed changes to the structure to give them an opportunity to veto the change.

10. The system of claim 1, further comprising a notification component that alerts consumers of the common structure of a change.

11. A software tool interaction system comprising:
a means for generating a common classification scheme amongst a plurality of unrelated software tools; and
a means for maintaining the common classification scheme to provide a foundation for a cohesive user experience.

12. The system of claim 11, wherein a user generates the classification scheme employing a graphical user interface to drag and drop artifacts onto classification nodes.

13. The system of claim 11, wherein the classification scheme is generated automatically utilizing heuristics and statistical analysis associated with artificial intelligence.

14. The system of claim 11, wherein maintaining the classification scheme comprises notifying consumers of the scheme of potential changes to allow them an opportunity to object.

15. The system of claim 11, wherein maintaining the scheme comprises notifying consumers of the scheme of changes thereto.

16. A common classification methodology comprising
generating one or more taxonomies;
maintaining the taxonomies to facilitate interaction with taxonomy artifacts by a plurality of unrelated tools.

17. The method of claim 16, wherein generating a taxonomy comprises defining node types and structural type classes.

18. The method of claim 17, wherein generating a taxonomy comprises defining structural constraints specifying parent-child relationships

19. The method of claim 16, wherein each node in a taxonomy is identified by an immutable globally unique node identifier.

20. The method of claim 16, wherein the taxonomy is generated by a user employing a graphical user interface.

21. The method of claim 20, wherein a user generates the taxonomy by dragging and dropping artifacts onto a classification node.

22. The method of claim 16, wherein the taxonomy is generated automatically by a component employing heuristics and statistical analyses related to artificial intelligence.

23. The method of claim 16, wherein maintaining the taxonomies includes notifying a user or owner of classifiable artifacts of changes to the taxonomy.

24. The method of claim 23, wherein a before change event is raised prior to a change to provide owners with an opportunity to veto proposed changes.

25. The method of claim of claim 23, wherein an after change event is raised to all owners to enable them to reflect a change that has been completed.

26. The method of claim 16, wherein the taxonomy is represented in XML.

27. A computer readable medium having stored thereon computer executable instructions for carrying out the method of claim 16.

28. A common enterprise classification scheme methodology comprising:
instantiating a common structure based on a structure type;
exposing the common structure amongst a plurality of unrelated tools to provide a foundation for a cohesive user experience.

29. The method of claim 28, wherein a structure type comprises node types and structural constraints.

30. The method of claim 28, wherein the common structure is exposed via a graphical user interface.

31. The method of claim 28, further comprising requesting consent from consumers of the common structure to proposed changes to the structure.

32. A computer readable medium having stored thereon computer executable instructions for carrying out the method of claim 28.
